(19) United States
(12) Patent Application Publication
(10) Pub. No.: US 2008/0263871 A1
(43) Pub. Date: Oct. 30, 2008

(54) Hair clipper with improved mounting structures

(75) Inventor: Yi-Tang Liao, Taichung County (TW)

Correspondence Address: BACON & THOMAS, PLLC, 625 SLATERS LANE, FOURTH FLOOR, ALEXANDRIA, VA, 22314-1176, US

(73) Assignee: JENG SHYUAN PRECISION CO., LTD., TAICHUNG COUNTY (TW)

(21) Appl. No.: 11/790,314

(22) Filed: Apr. 25, 2007

(51) Int. Cl. B26B 19/00

(52) U.S. Cl. 30/201

(57) ABSTRACT

An electric hair clipper for adjusting a cutter kit includes a combination housing having a first locating rib and a second locating rib. A motor is received inside the combination housing, the motor has a fixing means, a spindle is provided to rotate. A fixation mounter has a mounting seat fixed by the fixing means, a first locating slot and a second locating slot engaged with the first locating rib and second locating rib of the combination housing respectively. A driving roller set has an impelling roller eccentrically and rotatably connected to the spindle of the motor. A linking frame has two mounter fixing portions, a bridge connects the two mounter fixing portions. A swiveling leverage has a lever body, a driven portion and a blade driving portion connected to each end of the lever body. And a pivot set pivoted to the linking frame and the swiveling leverage.

### BACKGROUND OF THE INVENTION

1. Field of the Invention

The present invention relates to a hair clipper and more particularly to an electric hair clipper with improved mounting structures.

2. Description of the Related Art

In prior art, an electric hair clipper that provides a swiveling leverage being pivoted on a linking frame, the swiveling leverage can be driven to a swiveling motion, the linking frame is mounted on a mounter, and the mounter is only fixed to a housing of the hair clipper or formed integral with the housing.

Therefore, the vibration of the motor often loosened the mounter from the housing, the position of the swiveling leverage deviated relative to the motor, there also result resonance between the swiveling leverage and the motor, the hair clipper is uncomfortable in use and cannot cutting hair smoothly.

### SUMMARY OF THE INVENTION

The present invention has been accomplished under the circumstances in view. The main object of the present invention is to provide an electric hair clipper with improved mounting structures and a fixation mounter is fixed to the motor directly, the fixation mounter further located and positioned to the combination housing, thereby the assembly strength of the fixation mounter is stronger. The sub object of the present invention is to provide an electric hair clipper with improved mounting structures and a bridge of the linking frame is formed of arch shape, and the swiveling leverage is pivoted on the lower end of the bridge of the linking frame, the swiveling leverage can be simplified and reinforced.

To achieve those objects of the present invention, an electric hair clipper with improved mounting structures for adjusting a cutter kit, comprising: A combination housing has a first shell, a first locating rib and a second locating rib are formed inside the first shell, the second locating rib is perpendicular to the first locating rib, two support sockets are formed at two lateral inner sides of the first shell. A motor is received inside the combination housing, the motor has a fixing means, a spindle is provided to rotate. A fixation mounter has a mounting seat being fixed by said fixing means, a first locating slot and a second locating slot engaged with the first locating rib and second locating rib of the combination housing respectively, two support protrusions are supported by the support sockets of the combination housing. A driving roller set has a rotating head which is connected and driven by the spindle of the motor, a pivot axle is eccentrically connected to the rotating head relative to a rotating centerline of the spindle of the motor, an impelling roller rotatably pivoted to the pivot axle. A linking frame has two mounter fixing portions, a bridge connects the two mounter fixing portions. A swiveling leverage has a lever body, a driven portion is connected to the lever body, a blade driving portion connected to a front end of the lever body. And a pivot set is provided to pivot the linking frame and swiveling leverage.

Preferably, the fixing means of the motor is a bolt connected to the motor. Further, the impelling roller of the driving roller set is a bearing. And moreover, the linking frame has a pivot hole, the swiveling leverage has a pivot hole defining a pivot center aligned to the center of the pivot hole of the linking frame.

### BRIEF DESCRIPTION OF THE DRAWINGS

FIG. 1 is an exploded view of a hair clipper of a preferable embodiment according to the present invention.

FIG. 2 is an exploded view of part of the hair clipper of the embodiment according to the present invention.

FIG. 3 is a longitudinal section view of the embodiment according to the present invention.

FIG. 4 is a sectional view taken along line 4-4 of FIG. 3.

FIG. 5 is a sectional view taken along line 5-5 of FIG. 4.

FIG. 6 is a schematic drawing of the embodiment according to the present invention, showing a cutter kit assembling status.

FIG. 7 is similar to FIG. 6 but showing the operated status.

FIG. 8 is a schematic drawing of the embodiment according to the present invention, showing a status of swiveling of a side.

FIG. 9 is similar to FIG. 8 but showing swiveled another side status.

### DETAILED DESCRIPTION OF THE INVENTION

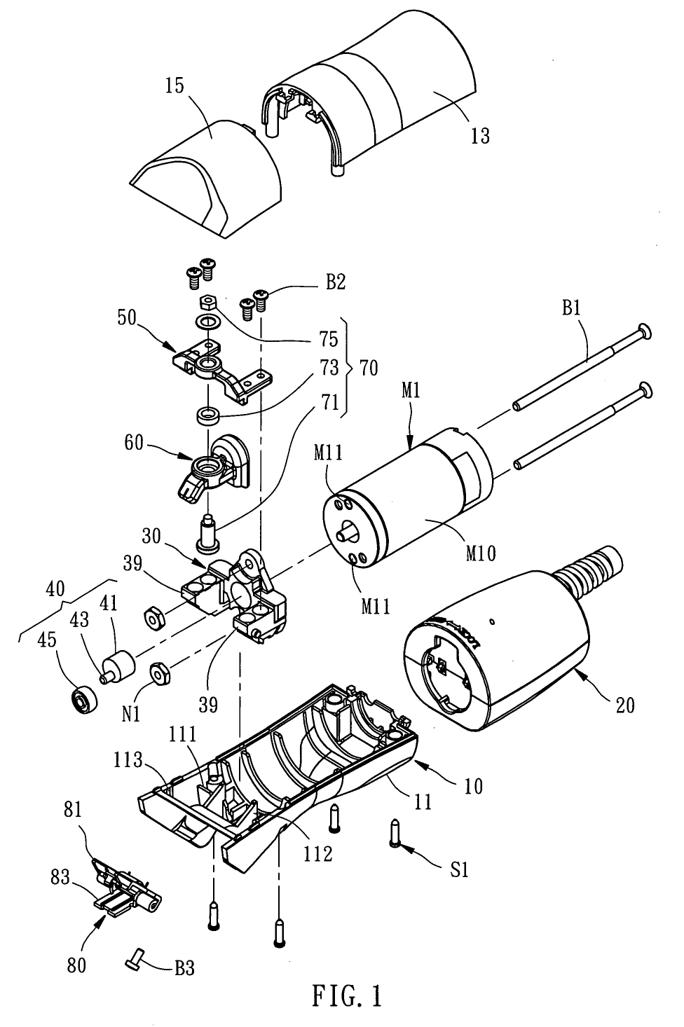

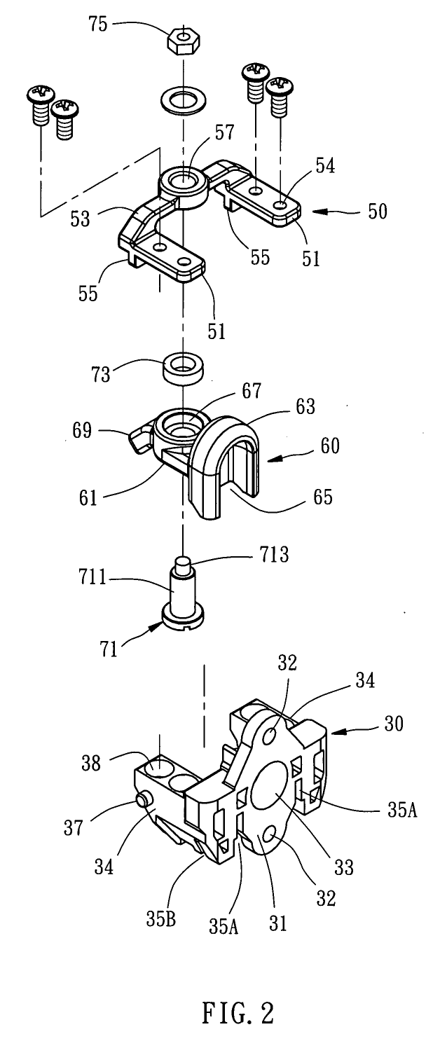

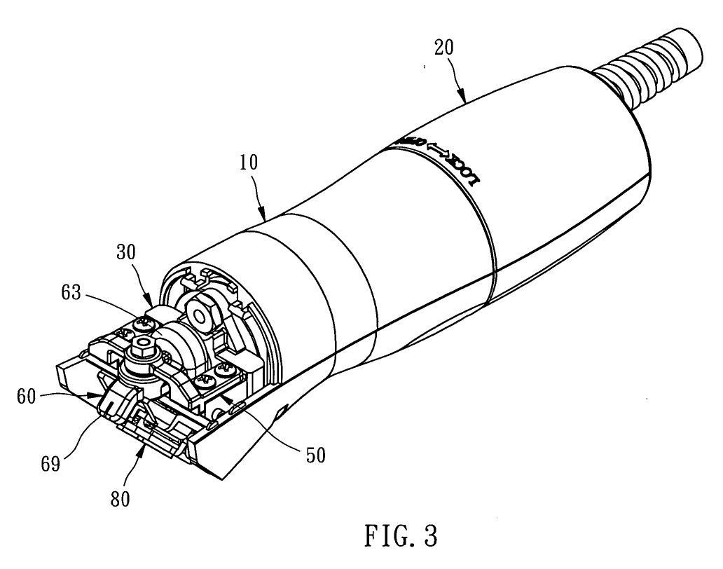

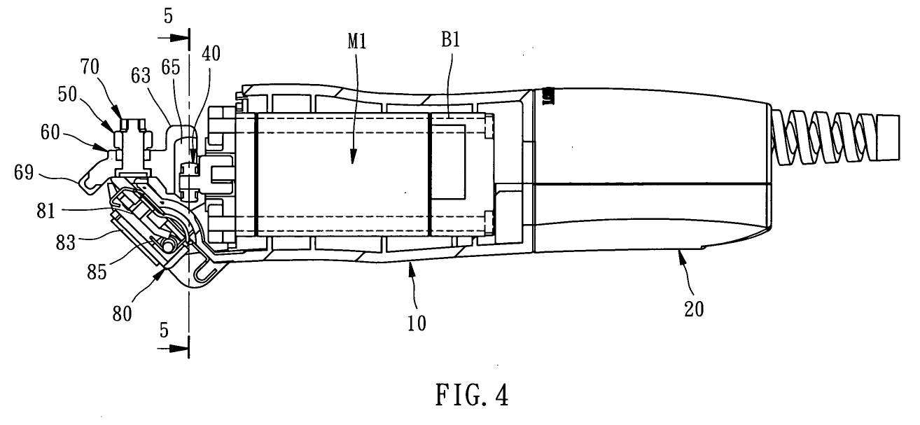

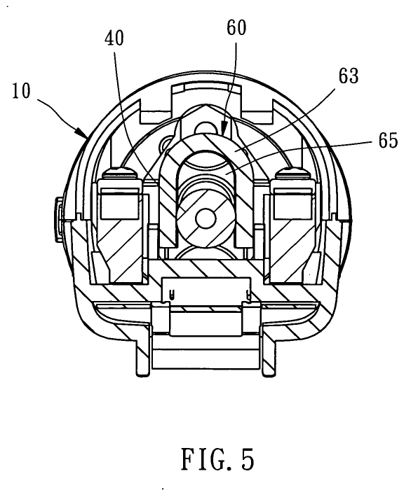

Referring to the FIGS. 1 to 7, an electric hair clipper with improved mounting structures is used to control the movement of a movable blade C2 of a cutter kit C; the cutter kit C further has a fixed blade C1, and a connect portion C11. The movable blade C2 has a driven portion C21.

The electric hair clipper comprises the follows.

A combination housing 10 has a first shell 11, the first shell 11 has two first locating ribs 111 and two second locating ribs 112 perpendicular to the first locating ribs 111, two support sockets 113 is formed at two lateral inner sides of the first shell 11; a second shell 13 and a third shell 15 covered on the first shell 11, and a receiving room formed inside between the first shell 11 and third shell 15. The second shell 13 and third shell 15 further fastened to the first shell 11 via a plurality of screws S1.

A motor M1 has a motor body M10 being received inside the combination housing 10, two bolting holes M11, a fixing means which comprises two motor-to-mounter bolts B1 and two nuts N1 threadable onto the bolts B1, and a spindle M15 is provided to rotate.

A power source 20 which is a battery set detachably connected to an end of the combination housing 10 and electrically conducted to the motor M1.

A fixation mounter 30 has a mounting seat 31, two motor connect portions 32 which each is a hole formed through the mounting seat 31 for passing of the each motor-to-mounter bolt B1 of the fixing means of the motor M1, a spindle escape hole 33 is hollowed through the mounting seat 31, two shell locating portions 34 each formed at two lateral sides of the mounting seat 31, two first locating slots 35A and two second locating slots 35B are engaged with the mounting seat 31, two support protrusions 37 are protruded from the mounting seat 31 and supported by the support sockets 113 of the combination housing 10, four threadholes 38 are opened on the mounting seat 31, and two limiting planes 39 which each is formed at a front end of the mounting seat 31.

A driving roller set 40 has a rotating head 41 which is connected and driven by the spindle M15 of the motor M1, a pivot axle 43 is eccentrically connected to the rotating head 41 relative to a rotating centerline of the spindle M15 of the motor M1, an impelling roller 45 which is a bearing rotatably pivoted to the pivot axle 43.

A linking frame 50 has two mounter fixing portions 51, a bridge 53 connects the two mounter fixing portions 51, four bolting holes 54 opened through the two mounter fixing portions 51 equally and relative to the four threadholes 38 of the fixation mounter 30, two front stoppers 55 each is formed at a bottom of each of the mounter fixing portion 51, each front stopper 55 is stopped against to the limiting plane 39 of the fixation mounter 30, a pivot hole 57 opened through the bridge 53 at a middle portion.

The hair clipper further provides four bolts B2 to pass through the bolting holes 54 of the linking frame 50 and then threaded on the thread holes 38 of the fixation mounter 30.

A swiveling leverage 60 has a lever body 61, a driven portion 63 is connected to the lever body 61, a driven channel 65 is opened at a back side of the driven portion 63, a pivot hole 67 is opened through the lever body 61 and having a pivot center aligned to the pivot hole 57 of the linking frame 50, a blade driving portion 69 is connected to a front end of the lever body 61.

A pivot set 70 has a pivot post 71 having a pivot portion 711 and a thread portion 713, a bearing 73 is rotatably pivoted to the pivot portion 711 and rotatably mounted inside the pivot hole 57 of the linking frame 50, and a nut 75 is threaded on the thread portion 713.

A cutter connect set 80 has a housing connect portion 81 which is fastened to the first shell 11 of the combination housing 10 via two bolts B3, a cutter connect portion 83 is pivoted to the housing connect portion 81, a torsion spring 85 is biased between the housing connect portion 81 and the cutter connect portion 83.

Therefore, the fixation mounter 30, driving roller set 40, linking frame 50, swiveling leverage 60 and pivot set 70 are all received in the receiving room of the combination housing 10.

Hereinafter are the descriptions of the assembly and operation of the hair clipper of the preferable embodiment of the present invention.

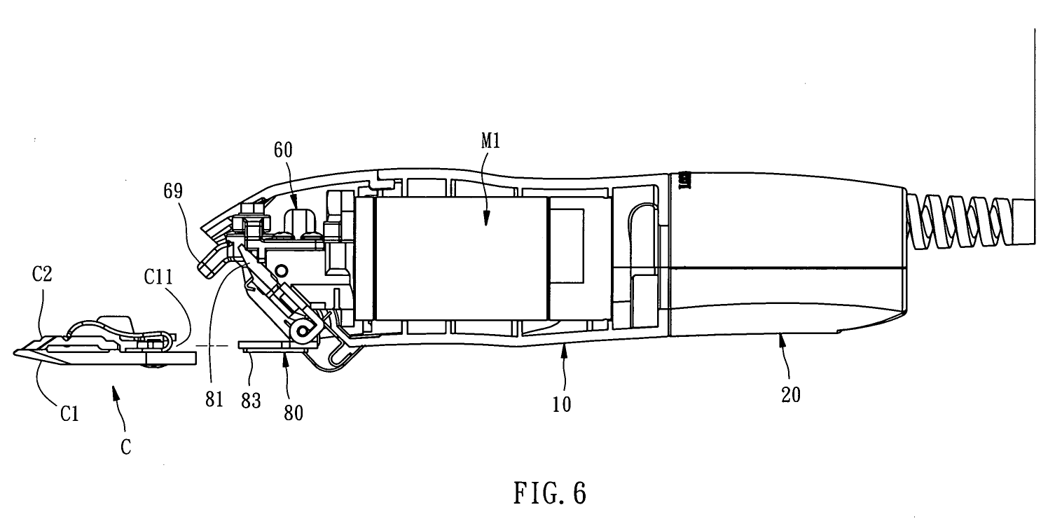

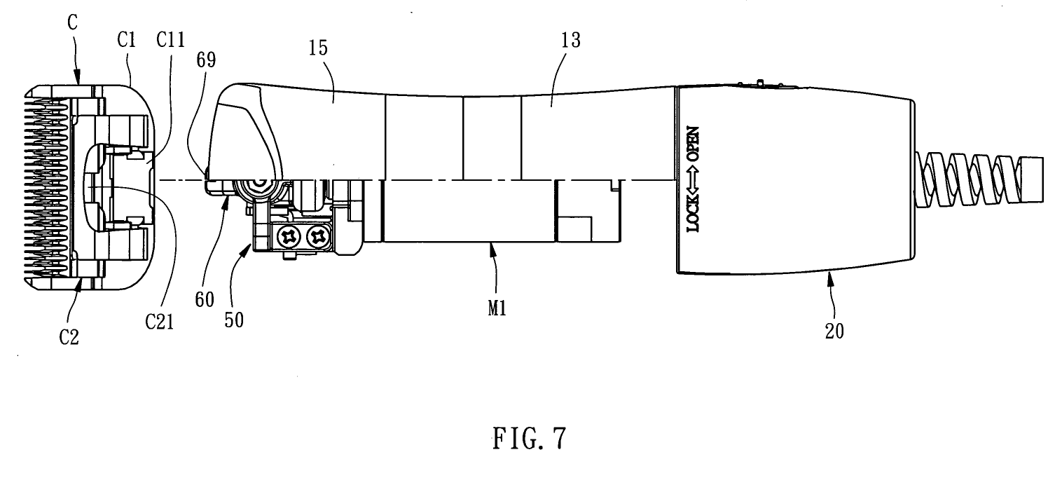

FIGS. 6 and 7 show the assembly of the cutter kit C to the hair clipper, first let the cutter connect portion 83 of the cutter connect set 80 turning an angle depart from the combination housing 10, then user holds the cutter kit C and let the connect portion C11 putting on the cutter connect portion 83 of the cutter connect set 80, at last, turning the cutter kit C and the cutter connect portion 83 back toward the combination housing 10, the cutter kit C then hold on the position for use via the spring back force provided by the torsion spring 85, in the mean time, the driven portion C21 of the cutter kit C receives the blade driving portion 69 of the swiveling leverage 60.

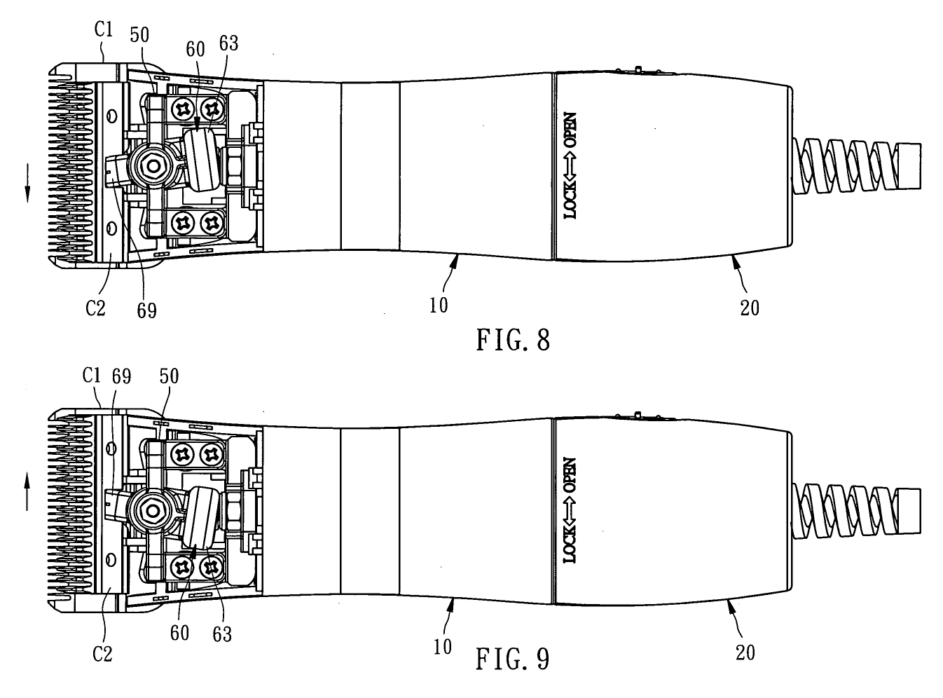

When the motor M1 is switched on, the spindle M15 drives the rotating head 41 to rotate the driving roller set 40, the impelling roller 45 then moved in a circular motion and driving the driven channel 65 of the swiveling leverage 60, the swiveling leverage 60 then swings to a first angle and a second angle back and forth about the pivot center (as shown in FIGS. 8 and 9), the blade driving portion 69 then drag the movable blade C2 moving about a linear direction back and forth.

Because the fixation mounter 30 is directly connected to the motor M1, hence the position of the swiveling leverage 60 relative to the motor M1 is more accurate, and then the blade driving portion 69 can drag the movable blade C2 moving at an exact right route and smoothly.

Further, the first locating slots 35A and second locating slots 35B of the fixation mounter 30 fitted to the first locating ribs 111 and second locating ribs 112 of the combination housing 10, therefore help the fixation strength and reduce the vibration of the cutter and motor.

The linking frame 50 is detachably assembled on the fixation mounter 30, since the swiveling leverage 60 can be assembled or replaced via detaching the linking frame 50 from the fixation mounter 30 conveniently.

Further, the pivot post of the pivot set can be formed or integrated on the linking frame or swiveling leverage for helping reduction of the parts and assemble.

Concluding with the aforesaid embodiment, the advantages of present invention are:

1. In the electric hair clipper with improved mounting structures of present invention, the fixation mounter is fixed to the motor directly, the fixation mounter further located and positioned to the first shell of the combination housing, thereby the assembly strength of the fixation mounter is stronger.

2. In the electric hair clipper with improved mounting structures of present invention, the bridge of the linking frame is formed of arch shape, and the swiveling leverage is pivoted on the lower end of the bridge of the linking frame, therefore the swiveling leverage can be simplified and reinforced.

What is claimed is:

1. An electric hair clipper with improved mounting structures for adjusting a cutter kit, said hair clipper comprising:
a combination housing having a first shell, a first locating rib being formed inside said first shell, a second locating rib being formed inside said first shell, said second locating rib being perpendicular to said first locating rib, two support sockets being formed at two lateral inner sides of said first shell;
a motor being received inside said combination housing, said motor having a fixing means, and a spindle being provided to rotate;
a fixation mounter having a mounting seat being fixed by said fixing means, a spindle escape hole hollowed through said mounting seat, a first locating slot engaged with said first locating rib of the combination housing, a second locating slot engaged with said second locating rib of the combination housing, two support protrusions supported by said support sockets of the combination housing;
a driving roller set having a rotating head which is connected and driven by said spindle of the motor, a pivot axle being eccentrically connected to said rotating head relative to a rotating centerline of said spindle of the motor, an impelling roller rotatably pivoted to said pivot axle;
a linking frame having two mounter fixing portions, a bridge connected said two mounter fixing portions;
a swiveling leverage having a lever body, a driven portion being connected to said lever body, a blade driving portion being connected to a front end of said lever body; and
a pivot set being provided to pivot said linking frame and swiveling leverage.

2. The hair clipper as claimed in claim 1, wherein said combination housing further has a second shell covered on the first shell, said motor being received inside between said first shell and second shell.

3. The hair clipper as claimed in claim 2, wherein said combination housing further has a third shell covered on said first shell and positioned at a side of said second shell, said fixation mounter, driving roller set, linking frame, swiveling leverage and pivot set being received inside between said first shell and third shell.

4. The hair clipper as claimed in claim 1, wherein said fixation mounter has a limiting plane, said linking frame has two front stoppers each formed at a bottom of each of said mounter fixing portion, each front stopper is stopped against to said limiting plane of the fixation mounter.

5. The hair clipper as claimed in claim 1, wherein said fixing means comprises a plurality of motor-to-mounter bolts, said fixation mounter has two motor connect portions formed through said mounting seat for fixing of said each motor-to-mounter bolt of the motor.

6. The hair clipper as claimed in claim 1, wherein said linking frame is fastened to the fixation mounter via a plurality of bolts threaded on the fixation mounter.

7. The hair clipper as claimed in claim 1, wherein said linking frame has a pivot hole opened through the bridge at a middle portion; said swiveling leverage has a pivot hole being opened through said lever body and having a pivot center aligned to the center of said pivot hole of the linking frame.

8. The hair clipper as claimed in claim 1, wherein said swiveling leverage has a driven channel being opened at a back side of said driven portion, said driven channel is provided reception of said impelling roller of the driving roller set.

9. The hair clipper as claimed in claim 1, wherein said pivot set has a pivot post, said pivot post has a pivot portion and a thread portion, a bearing is rotatably pivoted to said pivot portion and rotatably mounted inside said pivot hole of the linking frame, and a nut is threaded on said thread portion.

10. The hair clipper as claimed in claim 1, further comprising a cutter connect set having a housing connect portion which is fastened to said first shell of the combination housing, a cutter connect portion being rotatably pivoted to said housing connect portion.

11. The hair clipper as claimed in claim 10, wherein said cutter connect set further has a torsion spring biased between said housing connect portion and the cutter connect portion.

12. The hair clipper as claimed in claim 1, further comprising a power source which is a battery set detachably connected to an end of said combination housing and electrically conducted to said motor.
